(19) United States
(12) Patent Application Publication
(10) Pub. No.: US 2014/0049444 A1
(43) Pub. Date: Feb. 20, 2014

(54) PORTABLE ELECTRONIC DEVICES AND METHODS FOR POSITIONING ANTENNAS OF SUCH DEVICES

(71) Applicant: Rodney Owen Williams, Cary, NC (US)

(72) Inventor: Rodney Owen Williams, Cary, NC (US)

(73) Assignee: HTC CORPORATION, Taoyuan City (TW)

(21) Appl. No.: 13/586,384

(22) Filed: Aug. 15, 2012

(51) Int. Cl. H01Q 1/08; H01Q 1/22

(52) U.S. Cl. 343/882; 343/880

(57) ABSTRACT

A representative device includes: a housing; and an antenna assembly mounted to the housing, the antenna assembly having a first antenna and a second antenna, the first antenna and the second antenna being movable between respective stowed and extended positions; in the stowed positions, the first antenna and the second antenna being positioned substantially within an outer periphery defined by the housing.

### TECHNICAL FIELD

The present disclosure generally relates to electronic devices with antennas.

### BACKGROUND

Portable electronic devices such as tablet computers and smartphones include antennas for facilitating communications. Typically, an antenna of such a device is fixed in position. By way of example, an antenna may be located within an interior cavity of the device and surrounded by the device housing, which forms an exterior shell of the device. So configured, performance of the antenna may be altered due to various factors, such as the manner in which the device is held by a user.

### SUMMARY

Portable electronic devices and methods for positioning antennas of such devices are provided. Briefly described, one embodiment, among others, is an electronic device comprising: a housing; and an antenna assembly mounted to the housing, the antenna assembly having a first antenna and a second antenna, the first antenna and the second antenna being movable between respective stowed and extended positions; in the stowed positions, the first antenna and the second antenna being positioned substantially within an outer periphery defined by the housing.

Another embodiment is a method for positioning an antenna of a portable electronic device comprising: determining signal performance of a first antenna of the device, the device having the first antenna and a second antenna; and moving the first antenna and the second antenna based, at least in part, on the determined signal performance.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a portable electronic device.

FIG. 2 is a schematic diagram of an example embodiment of an antenna assembly.

FIG. 3 is a schematic diagram of another example embodiment of a portable electronic device.

FIG. 4 is a flowchart depicting an example embodiment of a method for positioning an antenna of a portable electronic device.

FIG. 5 is a schematic diagram of another example embodiment of a portable electronic device.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

In this regard, portable electronic devices and methods for positioning antennas of such devices are provided. In some embodiments, such a device is provided with a pair of antennas that are configured to pivot about respective axes of rotation. By way of example, the antennas may be elongate, extending radially from the axes so that distal ends of the antennas move in corresponding arcs. In some of these embodiments, the antennas are moved symmetrically, such that the movement of one of the antennas mirrors the other. Notably, the movement may be performed for one or more of various purposes, such as to enhance signal performance of the antennas, for example.

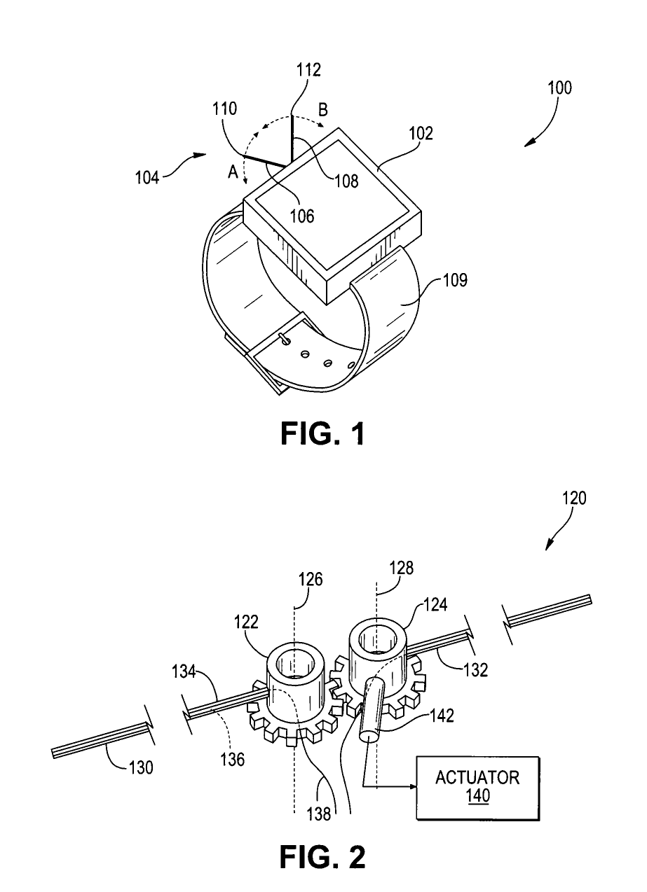

FIG. 1 is a schematic diagram of an example embodiment of a portable electronic device. As shown in FIG. 1, device 100 includes a device housing 102 and an antenna assembly 104. The antenna assembly is mounted to the housing and incorporates antennas 106, 108, with the antennas being movable between respective stowed positions and extended positions. Notably, the antennas 106, 108 are depicted in FIG. 1 between the stowed and extended positions (i.e., in intermediate positions). Note also that, in this embodiment, the housing is attached to a wristband 109.

Each of antennas 106, 108 is elongate and terminates in a corresponding distal end 110, 112. In this embodiment, antenna 106 pivots about an axis so that distal end 110 moves through an arc (arc A depicted in dashed lines), while antenna 108 pivots about another axis so that distal end 112 moves through an arc (arc B depicted in dashed lines).

In the intermediate positions (depicted in FIG. 1), as well as the extended positions, the antennas extend outwardly from the housing. In contrast, in the stowed positions, the antennas are positioned substantially within an outer periphery defined by the housing.

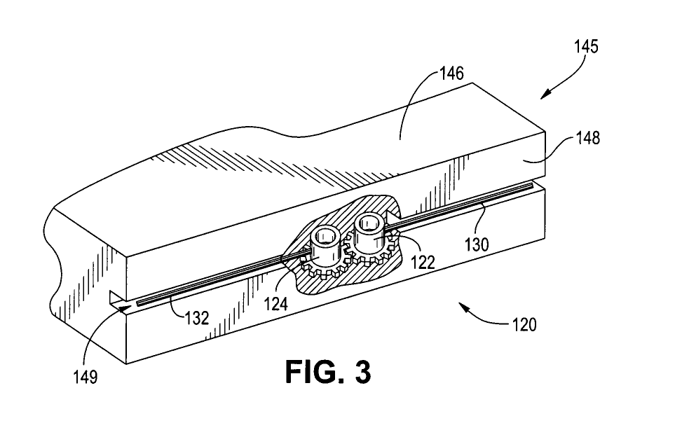

FIG. 2 is a schematic diagram of an example embodiment of an antenna assembly. As shown in FIG. 2, antenna assembly 120 incorporates hubs 122, 124, with the hubs being rotatable about respective axes 126, 128. An antenna 130 extends outwardly from hub 122 and an antenna 132 extends outwardly from hub 124. Components associated with antenna 130 will now be described in greater detail.

Antenna 130 includes a length of conduit 134 (e.g., a microtube), which is formed of electro-magnetically transparent material. In this embodiment, distal ends of the conduit may be sealed.

An antenna conductor 136 extends into the conduit, with the length of the conductor being optimized in this embodiment to be resonant at frequencies used by a transceiver of the device to which the antenna assembly is mounted. Although conductors of various types and materials may be used, an example conductor is formed of 304v 40AWG stainless steel ribbon. An antenna feed 138 extends through the hub and is coupled to the conductor.

Hub 142 drives hub 124 so that antennas 130, 132 move simultaneously. Specifically, in this embodiment, the hubs are geared hubs that include radially disposed gear teeth. The hubs engage each other such that rotation of the hubs causes the antenna to move in opposing rotational directions. For instance, movement of the antennas toward the extended positions causes the distal ends to move towards each other, and movement toward the stowed positions causes the distal ends to move away from each other.

An actuator 140 rotates hub 124. Specifically, the actuator engages an arm 142, which extends radially from the hub. The actuator may be a linear actuator that responds to control inputs provided by an antenna position controller (not shown in FIG. 2). Such an antenna position controller may control the actuator to position the antennas based on one or more of various parameters, such as signal performance of the device.

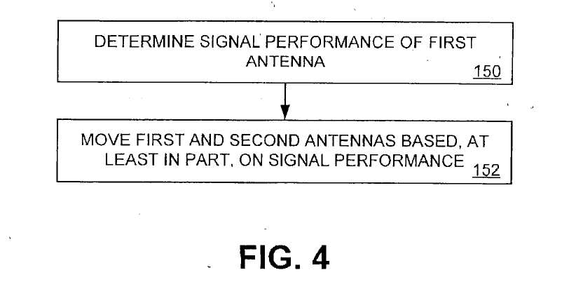

FIG. 3 is a schematic diagram of another example embodiment of a portable electronic device, in which antenna assembly 120 is mounted. As shown in FIG. 3, device 145 includes a device housing 146 that defines a peripheral edge 148. An elongate recess 149 is located along the edge. Notably, in the stowed positions, the antennas seat within the recess.

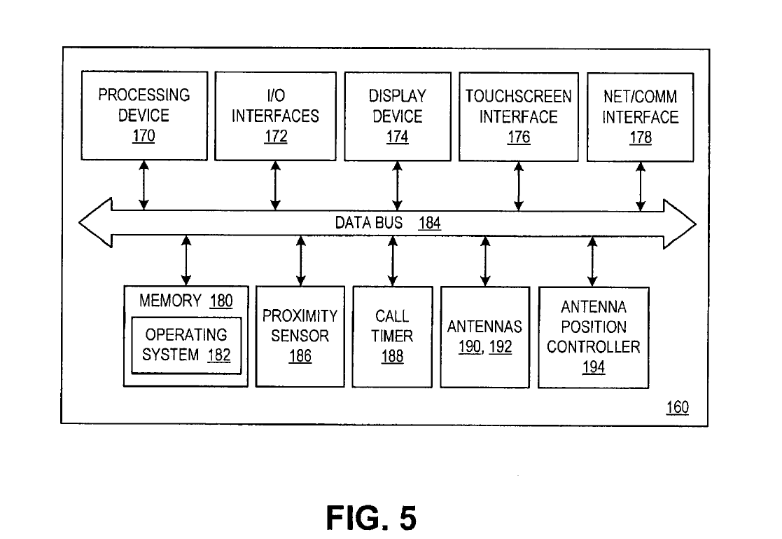

In this regard, FIG. 4 is a flowchart depicting an example embodiment of a method for positioning an antenna of a portable electronic device. As shown in FIG. 3, the method involves (in block 150) determining signal performance of a first antenna of the device. In block 152, the first and second antennas of the device are moved based, at least in part, on the determined signal performance.

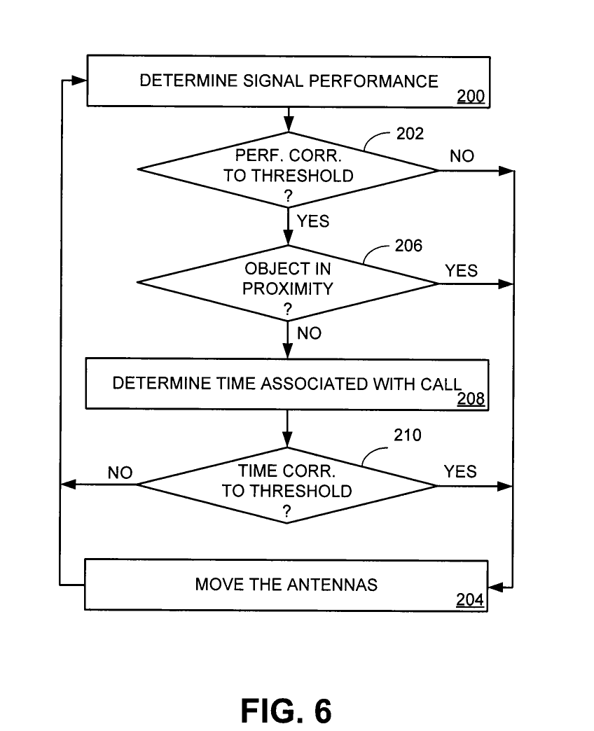

FIG. 5 is a schematic diagram of another example embodiment of a portable electronic device, which is configured as a mobile device capable of making a phone call (e.g., a smartphone). As shown in FIG. 4, device 160 includes a processing device (processor) 170, input/output interfaces 172, a display device 174, a touchscreen interface 176, a network/communication interface 178, a memory 180, and an operating system 182, with each communicating across a local data bus 184. Additionally, the device incorporates a proximity sensor 186, a call timer 188, antennas 190, 192 and an antenna position controller 194.

The processing device 170 may include a custom made or commercially available processor, a central processing unit (CPU) or an auxiliary processor among several processors, a semiconductor based microprocessor (in the form of a microchip), one or more application specific integrated circuits (ASICs), a plurality of suitably configured digital logic gates, and other electrical configurations comprising discrete elements both individually and in various combinations to coordinate the overall operation of the device.

The memory 180 may include any of a combination of volatile memory elements (e.g., random-access memory (RAM, such as DRAM, and SRAM, etc.)) and nonvolatile memory elements. The memory typically comprises native operating system 182, one or more native applications, emulation systems, or emulated applications for any of a variety of operating systems and/or emulated hardware platforms, emulated operating systems, etc. For example, the applications may include application specific software which may comprise some or all the components of the device. In accordance with such embodiments, the components are stored in memory and executed by the processing device.

Touchscreen interface 176 is configured to detect contact within the display area of the display device 174 and provides such functionality as on-screen buttons, menus, keyboards, soft keys, etc. that allows users to navigate user interfaces by touch.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 5, network/communication interface device 178 comprises various components used to transmit and/or receive data over a networked environment. By way of example, such components may include a wireless communications interface. When such components are embodied as an application, the one or more components may be stored on a non-transitory computer-readable medium and executed by the processing device.

Proximity sensor 186 is operative to determine proximity of an object to the device. By way of example, the proximity sensor may be configured to determine proximity of a user's face to the device. The proximity sensor communicates with the antenna position controller 194, which is operative to position antennas 190, 192 based, at least in part, input provided by the sensor. Notably, the input may include information corresponding to the proximity of an object to the device.

Additionally, or alternatively, the antenna position controller may receive input from call timer 188, which is operative to determine a time associated with a call performed by the device. Responsive to the input, the antenna position controller is operative to position the antennas based, at least in part, on the time of the call corresponding to a predetermined threshold. Notably, a user of the device may be exposed to less antenna radiation, as the antenna position controller causes periodic relocations of the antennas away from the tissue of the user. In some embodiments, repositioning may occur even if less than optimum reception is achieved in doing so.

Functionality associated with an embodiment of an antenna position controller is depicted in the flowchart of FIG. 6. As shown in FIG. 6, the functionality (or method) may be construed as beginning at block 200, in which signal performance of one or more of the antennas of an electronic device is determined. In block 202, if the signal performance does not correspond to a predetermined threshold, the process may proceed to block 204, in which the antennas are moved in an effort to improve the performance. If, however, the signal performance corresponds to the performance threshold, the process may proceed to block 204.

In block 204, a determination is made as to whether there are any objects in close proximity to the electronic device. By way of example, a proximity sensor of the electronic device may be used to determine if the user is in close proximity to the device and proximity information generated by the sensor may be provided to the antenna position controller. If an object is determined to be in proximity, the process may proceed to block 204 in which the antennas are moved responsive to the antenna position controller. However, if an object is not in proximity, the process may proceed to block 208.

In block 208 a time associated with a call is determined. Specifically, the time may correspond to the call time of a cell call being made by the electronic device, with information corresponding to the call time being provided to the antenna position controller. In block 210, if the time corresponds to a predetermined threshold, the process proceeds again to block 204 in which the antennas are moved. However, if the time does not correspond to the threshold, the process may return to block 200 and begin as described before.

If embodied in software, it should be noted that each block depicted in the flowchart of FIG. 4 (or any of the other flowcharts) represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

It should be emphasized that the above-described embodiments are merely examples of possible implementations. Many variations and modifications may be made to the above-described embodiments without departing from the principles of the present disclosure. By way of example, the systems described may be implemented in hardware, software or combinations thereof. All such modifications and variations are intended to be included herein within the scope of this disclosure and protected by the following claims.

At least the following is claimed:

1. A portable electronic device comprising:
a housing; and
an antenna assembly mounted to the housing, the antenna assembly having a first antenna and a second antenna, the first antenna and the second antenna being movable between respective stowed and extended positions;
in the stowed positions, the first antenna and the second antenna being positioned substantially within an outer periphery defined by the housing.

2. The device of claim 1, wherein:
the first antenna is elongate and terminates in a first distal end, the first antenna being pivotable about a first axis such that the first distal end moves through a first arc defined by the first axis; and
the second antenna is elongate and terminates in a second distal end, the second antenna being pivotable about a second axis such that the second distal end moves through a second arc defined by the second axis;

3. The device of claim 1, further comprising an antenna position controller operative to direct movement of the first antenna and the second antenna based, at least in part, on signal performance of the device.

4. The device of claim 3, wherein the antenna assembly is operative to move the first antenna and the second antenna in opposing rotational directions.

5. The device of claim 1, wherein:
the antenna assembly further comprises a first hub and a second hub, the first hub being rotatable about a first axis, the second hub being rotatable about a second axis; and
the first antenna extends outwardly from the first hub and the second antenna extends outwardly from the second hub.

6. The device of claim 5, wherein:
the first antenna comprises a first conduit and a first conductor extending into the first conduit; and
the first antenna comprises a second conduit and a second conductor extending into the second conduit.

7. The device of claim 6, wherein the first conduit and the second conduit are formed of electro-magnetically transparent material.

8. The device of claim 5, wherein the first hub is operative to drive the second hub such that the first antenna and second antenna move simultaneously.

9. The device of claim 8, wherein:
the first hub and the second hub are geared hubs; and
the first hub and the second hub engage each other such that movement toward the extended positions causes the distal ends to move towards each other, and movement toward the stowed positions causes the distal ends to move away from each other.

10. The device of claim 8, further comprising an actuator operative to drive the first hub.

11. The device of claim 8, further comprising means for driving the first hub.

12. The device of claim 1, wherein:
the device further comprises a proximity sensor and an antenna position controller;
the proximity sensor is operative to determine proximity of an object to the device; and
the antenna position controller is operative to position the first antenna and the second antenna based, at least in part, on proximity of an object to the device as determined by the proximity sensor.

13. The device of claim 1, wherein:
the device further comprises a call timer and an antenna position controller;
the call timer is operative to determine time associated with a call performed by the device; and
the antenna position controller is operative to position the first antenna and the second antenna based, at least in part, on the time of the call corresponding to a predetermined threshold.

14. The device of claim 1, wherein:
the housing has a peripheral edge and a recess located along the edge; and
in the stowed positions, the first antenna and the second antenna seat within the recess.

15. The device of claim 1, wherein:
the device further comprises a wristband; and
the housing is mounted to the wristband.

16. A method for positioning an antenna of a portable electronic device comprising:
determining signal performance of a first antenna of the device, the device having the first antenna and a second antenna; and
moving the first antenna and the second antenna based, at least in part, on the determined signal performance.

17. The method of claim 16, wherein, in determining signal performance, signal performance of the second antenna also is determined.

18. The method of claim 16, wherein, in moving the first antenna and the second antenna, the first antenna is pivoted about a first axis and the second antenna is pivoted about a second axis.

19. The method of claim 16, wherein:
the method further comprises detecting proximity of an object to the device; and
moving further comprises moving the first antenna and the second antenna based, at least in part, in response to detecting an object proximate to the device.

20. The method of claim 16, wherein:
the method further comprises determining time associated with a call performed by the device; and
moving further comprises moving the first antenna and the second antenna based, at least in part, in response to the time of the call corresponding to a predetermined threshold.
